(19) United States
(12) Patent Application Publication
(10) Pub. No.: US 2001/0012789 A1
(43) Pub. Date: Aug. 9, 2001

(54) PORTABLE MOBILE TERMINAL EQUIPMENT SYSTEM CAPABLE OF TRANSFERRING TELEPHONE NUMBER DATA

(76) Inventor: ATSUSHI SASAKI, KANAGAWA (JP)

Correspondence Address: PAUL J ESATTO JR, SCULLY SCOTT MURPHY & PRESSER, 400 GARDEN CITY PLAZA, GARDEN CITY, NY, 11530

(21) Appl. No.: 09/170,762

(22) Filed: Oct. 13, 1998

(30) Foreign Application Priority Data
Oct. 31, 1997 (JP) 300817/1997

(51) Int. Cl. H04B 1/38; H04M 1/00

(52) U.S. Cl. 455/564; 455/566

(57) ABSTRACT

In a portable mobile terminal equipment, a plurality of dial data is read out from a storage unit in response to a display instruction and displayed on a display section. Specific dial data are designated from among the plurality of displayed dial data in response to a designate instruction. The specific dial data are read out and transmitted to a counter mobile terminal equipment via a base station. The transmitted specific data are stored in a storage unit of the counter mobile terminal equipment.

### BACKGROUND OF THE INVENTION

1. Field of the Invention

The present invention relates to a portable mobile terminal equipment system, and more particularly, to a portable mobile terminal equipment in which a dial data can be transferred and stored through radio communication.

2. Description of the Related Art

In a conventional portable mobile terminal equipment system, when a dial data stored in a memory unit of a portable mobile terminal equipment is transferred to another portable mobile terminal equipment, a user of the portable mobile terminal equipment reads out the dial data from the memory unit and tells the dial data. A user of the other portable mobile terminal equipment registers the dial data into a memory unit through the operation of his terminal equipment. Therefore, as the number of dial data to be transferred increases, the more time is required to process the dial data. Also, there are many cases that erroneous data is eventually entered due to a hearing mistake, an input mistake, or the like.

Otherwise, in case of a maintenance such as repair of a portable mobile terminal equipment, the stored data in the portable mobile terminal equipment is previously saved in an external equipment 50 such as a personal computer using a transfer software 51, as shown in FIG. 1. That is, an external interface section 54 of the portable mobile terminal equipment 52 to be subjected to the maintenance and an external interface section 55 of another portable mobile terminal equipment 53 are connected through the external equipment 50. A dial data stored in a non-volatile memory 56 of the portable mobile terminal equipment 52 is once transferred into a non-volatile memory 57 of the other portable mobile terminal equipment 53. Then, after completion of the repair of the portable mobile terminal equipment 52, the transferred dial data is returned from the nonvolatile memory 57 to the non-volatile memory 56 of the portable mobile terminal equipment 52.

In this case, however, since the external equipment 52 and transfer software 51 are necessary, the maintenance costs rise.

A radio communication data transmission system is described in Japanese Laid Open Patent Application (JP-A-Showa 63-209244). In this reference, a portable terminal equipment and a central processing apparatus. The portable terminal equipment is composed of a data input circuit, a storage circuit, an error correction and detection coding circuit and a transmitting and receiving circuit. The central processing apparatus a data processing section, a line control section and radio terminal units. The radio terminal unit is composed of a storage circuit, an error correction and detection coding circuit and a transmitting and receiving circuit. The line control section establishes a line between one of the portable equipments and one of the radio terminal units in response to a data transmission request from the portable equipment. Then, transmission of data is performed between the portable equipment and the radio terminal unit such that the data is stored in a memory of the radio terminal unit. The data processing section sequentially reads out the data stored in the memory of the radio terminal unit by a polling method.

A portable radio telephone apparatus is described in Japanese Laid Open Patent Application (JP-A-Heisei 5-183503). In this reference, the portable radio telephone apparatus is composed of a parent telephone and a child telephone. The child telephone is provided with a data inputting and outputting section to exchange data with the parent telephone when the child telephone is connected with the parent telephone through a connector. A data stored in the child telephone is transferred to the parent telephone through the data inputting and outputting section and the connector. The transferred data is stored in a data storage unit of the parent telephone. The data is edited by a user in the parent telephone. Then, the edited data is transfer from the parent telephone to the child telephone through in a direction opposite to the above-mentioned direction.

A portable communication apparatus is described in Japanese Laid Open Patent Application (JP-A-Heisei 7-66771). In this reference, the portable communication apparatus is composed of a data processing unit and a portable telephone apparatus to be connected to the data processing unit by a cable. The data processing unit is composed of a control unit, a display unit, an input unit, a rewritable storage unit and a connection section. The portable telephone apparatus is composed of a control section, a radio communication section, a data control section, a rewritable storage section, and a connection section. A data stored in the storage unit of the data processing apparatus is transferred from the data processing apparatus to the portables telephone apparatus via the connection sections in response to a data transfer request from the data processing apparatus or the portables telephone apparatus.

A portable telephone apparatus is described in Japanese Laid Open Patent Application (JP-A-Heisei 8-33047). In this reference, the portable telephone apparatus has only a function to originate a call and a pager has only a function to receive a call. The pager stores a telephone number transmitted with the call in a memory. The pager is physically connected to the portable telephone apparatus. When receiving a request from the portable telephone apparatus, the pager transfers the telephone number to the portable telephone apparatus. Thus, the portable telephone apparatus can originate a call to a party having the telephone number.

A portable data terminal equipment system is described in Japanese Laid Open Patent Application (JP-A-Heisei 8-335995). In this reference, a portable terminal equipment has a pager function. When a child equipment receives a data from an originator through a telephone line, the child equipment transmits a notice to the portable terminal equipment if the originator is a registrant. The portable terminal equipment receives the notice using the pager function and receives the data from the child equipment using a telephone line.

### SUMMARY OF THE INVENTION

The present invention is accomplished in view of the above problems. Therefore, an object of the present invention is to provide a portable mobile terminal equipment, in which a dial data transferring efficiency is improved, and a portable mobile terminal equipment system.

Another object of the present invention is to provide a portable mobile terminal equipment, in which the operability and the easiness of maintenance are improved, and a portable mobile terminal equipment system.

Still another object of the present invention is to provide a portable mobile terminal equipment, in which the dial data can be transferred using the inherent radio communicating function of the portable mobile terminal equipment.

Yet still another object of the present invention is to provide a method of transferring dial data in the above portable mobile terminal equipment.

In order to achieve an aspect of the present invention, a portable mobile terminal equipment includes a transmission section for transmitting a data, a storage section for storing a plurality of dial data, a control section for reading out specific ones of the plurality of dial data from the storage section, and for controlling the transmission section to transmit the specific dial data.

The portable mobile terminal equipment may further include a display section for displaying the plurality of dial data. In this case, the control section controls the display section to display the plurality of dial data in response to a dial data display instruction, and the specific dial data are designated from among the plurality of displayed dial data in response to a designate instruction.

In the above, the plurality of dial data may be classified into a plurality of groups, and the specific dial data are designated in units of groups. Instead, the specific dial data may be designated one by one.

Also, the portable mobile terminal equipment may further include a receiving section for receiving data. In this case, the control section controls the receiving section to receive transmitted specific dial data, and then stores the received specific dial data in the storage section.

In order to achieve another aspect of the present invention, a method of transferring dial data in a portable mobile terminal equipment, includes the steps of:

reading out specific ones of a plurality of dial data from a storage section; and

transmitting the specific dial data.

In order to achieve still another aspect of the present invention, a portable mobile terminal equipment, includes a storage section for storing a plurality of dial data, a reading section for reading out specific ones of a plurality of dial data from a storage section, and a transmitting section for transmitting the specific dial data.

The portable mobile terminal equipment may further includes a displaying section for displaying the plurality of dial data in response to a dial data display instruction, and a designating section for designating the specific dial data from among the plurality of displayed dial data in response to a designate instruction.

### BRIEF DESCRIPTION OF THE DRAWINGS

FIG. 1 is a block diagram illustrating a conventional portable mobile terminal equipment system;

FIG. 2 is a block diagram illustrating a portable mobile terminal equipment system according to an embodiment of the present invention;

FIG. 3 is a diagram illustrating the content of a non-volatile memory in a first example; and

FIG. 4 is a diagram illustrating the content of a non-volatile memory in a second example.

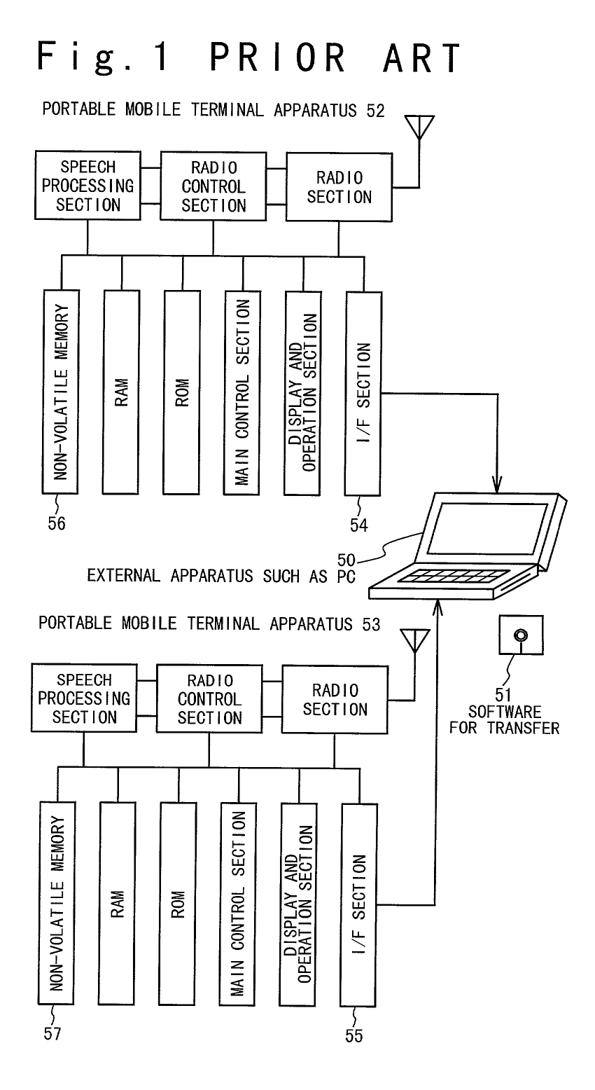

### DESCRIPTION OF THE PREFERRED EMBODIMENTS

A portable mobile terminal equipment system using a portable mobile terminal equipment of the present invention will be described below in detail with reference to the attached drawings.

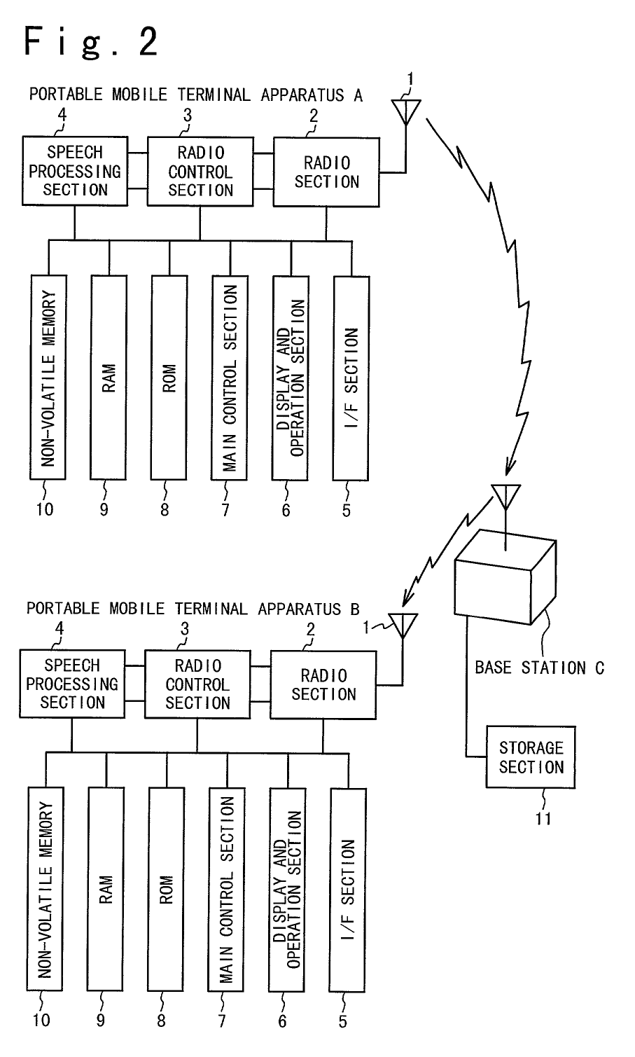

FIG. 2 is a block diagram illustrating the portable mobile terminal equipment system according to the embodiment of the present invention. Referring to FIG. 2, the portable mobile terminal equipment system is composed of a portable mobile terminal equipments A and B and a base station C. The portable mobile terminal equipment A is a call originating source and the portable mobile terminal equipment B is called by radio communication through the base station C.

Each of the portable mobile terminal equipments A and B is composed of an antenna 1, a radio section 2, a radio control section 3, a speech processing section 4, an external interface (I/F) section 5, a display and operation section 6, a main control section 7, a ROM 8, a RAM 9 and a non-volatile memory 10. The radio unit 2 performs a radio communication such as transmission and reception via the antenna 1. The radio control unit 3 controls the radio section 2. The speech processing section 4 is used for an audio communication via the base station C with another portable mobile terminal equipment or with a telephone connected to a public telephone line network or the like. The external interface (I/F) section 5 is connected to an external apparatus. The display and operation section 6 performs various operations such as a speech inputting operation, a dialing operation, a dial data registering operation, a dial data transferring operation, and the like. Also, the display and operation section 6 performs display based on the operations. The main control section 7 controls the whole apparatus. The ROM 8 stores a control program previously. The RAM 9 is used as a work area. The non-volatile memory 10 stores the dial data or the like.

In addition to functions similar to those of the conventional portable mobile terminal equipment, the main control section 7 has a function to allow the dial data stored in the non-volatile memory 10 to be displayed on the display and operation section 6 in accordance with the program stored in the ROM 8. The main control section 7 also has a function to allow the user to select arbitrary dial data in the displayed dial data.

In addition to functions similar to those of the conventional portable mobile terminal equipment, the radio control section 3 has a function to control the radio section 2 so that the dial data selected by the main control section 7 can be transmitted to the portable mobile terminal equipment B by a radio transmission by the radio section 2 and can be stored in the non-volatile memory 10 of the portable mobile terminal equipment B.

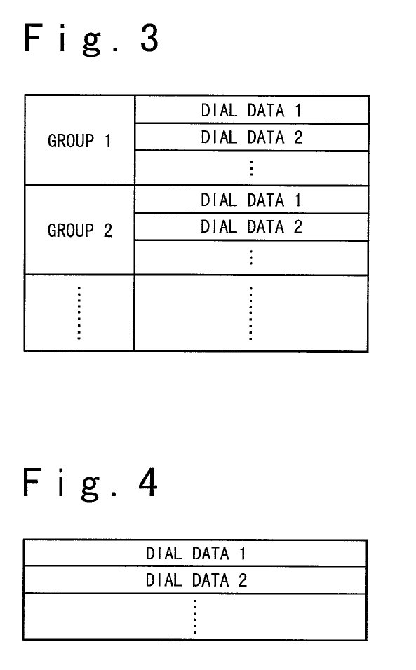

The dial data may be stored in the nonvolatile memory 10 in unit of groups as shown in FIG. 3, or individually as shown in FIG. 4.

The operation of the portable mobile terminal equipment will now be described.

In the portable mobile terminal equipment A as the call originating source, when the display and operation section 6 is operated, a dial data display instruction is generated. The dial data stored in the non-volatile memory 10 is displayed on the display and operation section 6 in response to the dial data display instruction.

An arbitrary one or a plurality of dial data as a group are selected from among the displayed dial data through the operation of the display and operation section 6. Only the selected dial data are sent to the radio section 2 and transmitted to the base station C under the control of the radio section 2 by the radio control section 3.

The dial data may be also transmitted such that the dial data stored in the non-volatile memory 10 is displayed by operating the display and operation section 6 during the speech communication and the arbitrary one or the plurality of dial data is selected from among the displayed dial data. Subsequently, the selected dial data is subjected to the transmitting operation.

In the portable mobile terminal equipment B, the dial data transmitted from the base station C is received by the radio section 2 under the control of the radio section 2 by the radio control section 3 and is stored into the nonvolatile memory 10 by the main control section 7 in accordance with the program stored in the ROM 8. Therefore, after this process, the portable mobile terminal equipment B can dial using the dial data transferred from the portable mobile terminal equipment A of the call originating source.

In the case where a special data has been predetermined between the terminal equipment A and the base station C, the special data is inputted from the display and operation section 6 and is dialed. After a speech communication state is set, the dial data stored in the non-volatile memory 10 is displayed. When the arbitrary one or the plurality of dial data are selected from among the displayed dial data, a transferring operation of the selected dial data is executed. The dial data can be stored into a storage section 11 of the base station C based on the special data at this time.

As described above, according to the present invention, since the dial data can be transferred between the portable mobile terminal equipments by using the radio communicating function inherent to the portable mobile terminal equipment as it is, the troublesomeness and mistake in the conventional apparatus can be eliminated. Therefore, the troublesomeness and mistake do not occur when the message is orally transferred to the counter destination one by one and is registered on the counter side. Thus, the dial data transferring efficiency can be improved and the accuracy can be assured.

Since the external apparatus such as a personal computer or the like and the transfer software which are necessary at the time of the maintenance such as a repair or the like are unnecessary, the operability and the easiness of maintenance can be improved and the costs can be reduced.

What is claimed is:

1. A portable mobile terminal equipment comprising:
a transmission section for transmitting a data;
a storage section for storing a plurality of dial data;
a control section for reading out specific ones of said plurality of dial data from said storage section, and for controlling said transmission section to transmit said specific dial data.

2. A portable mobile terminal equipment according to claim 1, further comprising a display section for displaying said plurality of dial data, and wherein said control section controls said display section to display said plurality of dial data in response to a dial data display instruction, and said specific dial data are designated from among said plurality of displayed dial data in response to a designate instruction.

3. A portable mobile terminal equipment according to claim 1, wherein said plurality of dial data are classified into a plurality of groups, and said specific dial data are designated in units of groups.

4. A portable mobile terminal equipment according to claim 1, wherein said specific dial data are designated one by one.

5. A portable mobile terminal equipment according to claim 1, further comprising a receiving section for receiving data, and
wherein said control section controls said receiving section to receive transmitted specific dial data, and then stores the received specific dial data in said storage section.

6. A method of transferring dial data in a portable mobile terminal equipment, comprising the steps of:
reading out specific ones of a plurality of dial data from a storage section; and
transmitting said specific dial data.

7. A method according to claim 6, further comprising the steps of:
displaying said plurality of dial data in response to a dial data display instruction; and
designating said specific dial data from among said plurality of displayed dial data in response to a designate instruction.

8. A method according to claim 6, wherein said plurality of dial data are classified into a plurality of groups, and said specific dial data are designated in units of groups.

9. A method according to claim 6, wherein said specific dial data are designated one by one.

10. A method according to claim 6, further comprising the steps of:
receiving specific dial data transmitted thereto; and
storing the received specific dial data in said storage section.

11. A portable mobile terminal equipment, comprising:
a storage section for storing a plurality of dial data;
reading means for reading out specific ones of a plurality of dial data from a storage section; and
transmitting means for transmitting said specific dial data.

12. A portable mobile terminal equipment according to claim 11, further comprising:
displaying means for displaying said plurality of dial data in response to a dial data display instruction; and
designating means for designating said specific dial data from among said plurality of displayed dial data in response to a designate instruction.

13. A portable mobile terminal equipment according to claim 11, wherein said plurality of dial data are classified into a plurality of groups, and said specific dial data are designated in units of groups.

14. A portable mobile terminal equipment according to claim 11, wherein said specific dial data are designated one by one.

15. A portable mobile terminal equipment according to claim 11, further comprising the steps of:
receiving means for receiving specific dial data transmitted thereto; and
storing means for storing the received specific dial data in said storage section.
